(19) United States
(12) Patent Application Publication
(10) Pub. No.: US 2009/0003583 A1
(43) Pub. Date: Jan. 1, 2009

(54) METHOD FOR ENHANCING CALL CENTER PERFORMANCE

(75) Inventors: Carmine J. CARRETTO, Richmond, VA (US); Jason FERGUSON, Midlothian, VA (US); Sara E. FRANKLIN, Richmond, VA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WELLPOINT, INC., Indianapolis, IN (US)

(21) Appl. No.: 12/013,765

(22) Filed: Jan. 14, 2008

Related U.S. Application Data
(60) Provisional application No. 60/880,198, filed on Jan. 12, 2007.

(51) Int. Cl. H04M 5/00

(52) U.S. Cl. 379/265.06

(57) ABSTRACT

A method for improving call center performance. The method includes the steps of, for each call, collecting data comprising: date, supervisor, associate, and a categorization as to single, last, or transfer; summarizing said data on a periodic basis by supervisor, associate, and percentage of single, last, transfer, and stream, wherein percentage of stream is the residual after subtracting said percentage of single, last, and transfer categories; and presenting said summarized data to supervisors to provide feedback on the effectiveness of said supervisor's call coaching of associates. A system for enhancing call center performance is also provided.

### RELATED APPLICATIONS

This patent application claims priority from Provisional Application Ser. No. 60/880,198, filed on Jan. 12, 2007, the contents of which are hereby incorporated by reference in their entirety.

### FIELD OF THE INVENTION

This invention is in the field of telephone call center management and, more particular, in the field of improving the efficiency of human operations and customer satisfaction within the call center environment.

### BACKGROUND OF THE INVENTION

There are many situations where a person takes the first step in a transaction with a business that requires further steps to finish the transaction. One example is placing an order for goods with a supplier. When the goods do not arrive on time, often the customer will call the supplier to expedite delivery. Another example is a call to determine if payment was received for a particular bill. Still another example is filling a claim for insurance coverage after an accident. Yet, still another example is ordering airline tickets over the phone or booking reservations. These transactions are typically episodic. They occur at most a few times per year. The transaction takes place by phone for convenience, requires a phone call to be finished, or the customer encounters a problem and makes a phone call to resolve some remaining issue.

Medical health insurance follows a similar pattern. Most people in the United States and other developed counties are covered by some form of health insurance. Employers, on behalf of employees, or individuals, themselves, purchase health insurance to cover future medical and dental procedures. Typically, such plans provide varying degrees of coverage. Some procedures are not covered, while others are covered up to certain limits or may be covered for a specified percentage and there may be deductibles that the insured must pay before insurance proceeds are applied. There are a wide variety of plans. This confusing array can result in the insured, as well as the insurance companies, having to resolve many issues to determine the proper amount of coverage for each individual.

For the sake of efficiency, insurers or a group of insurers have set up call centers to receive telephone inquires from the insured to explain the extent of coverage, when reimbursements will be mailed out or paid directly to medical providers and the like. This verbal interchange is handled by trained customer service representatives (also known as “associates” or “agents”) who hopefully understand the system and the terms of insurance contracts enough to authorize appropriate payments and explain insurance coverage to the caller. The insured, which are in fact customers, directly or indirectly of the insurance companies are, understandably, interested in resolving their questions favorably and with the least expenditure of time on their part.

These calls centers are called “inbound call centers.” Another class is called “outbound call centers.” A typical example of an outbound call center is a telemarketing operation, but outbound calls are used to alert costumers for other purposes.

More generally, call centers are often contact centers and handle both postal and internet communications. Many house interactive voice recognition (IVR) systems to handle routine calls or preliminaries before an associate is connected.

Inbound call centers are often staffed by a large number of associates in the same location or in different locations, but in communication by phone and the Internet to provide a virtual call center.

An important management tool for inbound call centers is automatic call distribution. These usually do more than route the next caller to the next available associate. For example, the associate who has been idle the longest may be selected on the assumption that they will have had the most time to process procedures after the last call they handled. More sophisticated systems use IVR preliminaries to match the problem with an associate having a particular skill set.

For some time, call centers have kept track of calls by entering transaction data concerning each call into a computerized database, termed a “data warehouse.” On reason is that, after the associate is finished, information needs be sent to other operations, e.g., shipping, accounting, etc., to follow up. Another reason is that customers may call back about the same or a related issue and the information will be available about what happened on the preceding call.

Call center managers have also looked at call data to improve efficiency. A major emphasis is on matching staff to call center volume. This involves keeping agents busy and reducing call times. In a sales operation, emphasis may be placed on sales volume. When no sales are involved, other metrics are used. In both cases, supervisors use various forms of call coaching. Agents may have scripts, even on-screen, but every caller has slightly different needs. Call coaching is an attempt to structure calls in stages and provide general guidance. One of several metrics focuses on first call resolution, resolving all issues on the first call. However, while the concept is simple enough, it is not well developed.

In the context of health insurance claims processing, the 1996 Federal Health Insurance Portability and Accountability Act (HIPPA) resulted in the Department of Health and Human Services promulgating a set of regulations that cover electronic health care transactions. This must be followed in health insurance claims processing but, with suitable safeguards they do not affect operation of the invention.

A number of systems and methods have been proposed with the aim of improving call center performance. For example, U.S. Pat. No. 5,239,460 proposes an arrangement for motivating telemarketing agents. In the system proposed, motivational feedback information, such as the number of bonus points earned, is displayed on agents' terminal displays. The system is said to combine an objective, quantitative measure, such as the number of calls handled, and a subjective, qualitative measure, such as a quality factor representing a supervisor's evaluation of the agents' observed performance in handling calls. In one form, the per-call quantitative measure is said to be multiplied by an agent's presently-assigned qualitative measure to arrive at the per-call number of bonus points earned by the agent.

U.S. Pat. No. 5,500,795 proposes a method and system for monitoring and controlling the performance of a call processing center. The method is said to include the steps of describing a plurality of performance variables associated with the organization. The performance variables are said to describe measurable properties of the organization. The method and system proposed further maps each of the performance variables to a normalized performance variable mapping that is said to have a neutral value and at least one inflection point of the performance variables within a normalized range of values. Each inflection point is said to describe effects of the normalized performance variable in changing from a positive influence to a negative influence on the organization's efficiency. Then the method and system proposed assigns a weighting factor to each of the normalized performance variables to produce a plurality of weighted normalized performance variables. The method and system calculates the efficiency of the organization as a function of the plurality of weighted normalized performance variables. The method and system further include the use and maintenance of instruction tables for identifying interactions among the various performance variables.

U.S. Pat. Nos. 6,459,787 and 6,775377 propose a method and system for delivery of individualized training to call center agents. It is proposed that agent interactions are recorded by a quality monitoring component of the call center to produce an agent performance record. The agent performance record is scored against predetermined performance criteria to produce an agent score. Training materials are assigned to agents based on the agent score in skill areas corresponding to the subject matter of the particular training materials. The agent score is coded and the training materials are categorized according to the associated subject matter. If an agent score is below a predetermined threshold, then a database record is populated with the agent score and a training material identifier. The database may then be polled to determine whether the agent needs the training materials to address the associated subject matter. It is proposed that the assigned training materials be delivered to the agent over the communications network.

U.S. Pat. No. 6,847,711 proposes a method for evaluating customer call center system designs. In the proposed method, a system is put into use and data collected to quantify various quality of service factors. Each quality of service factor is multiplied times an expense multiplier and added to an agent cost factor. The result is a metric that is said to describe the system in monetary terms.

U.S. Patent Publication No. 2002/0147632 proposes a method of managing a contact center that is said to include the preparation of a plan for a forthcoming period, such as one working day, on a per agent basis for a plurality of agents. It is proposed that variance from this plan be measured for each of a plurality of shorter periods, not exceeding one half working day. Communication to the agent of variances that exceed a threshold is performed, at least at the frequency of the shorter periods. Optionally, variances that do not exceed the threshold are noted for subsequent discussion, for example at a scheduled meeting.

U.S. Patent Publication No. 2006/0047566 proposes a method and system for improving performance of customer service representatives. The method and system proposed is said to include the steps of establishing a target performance grade, collecting a set of quantitative data generated as a result of customer contact, collecting a set of qualitative data input characterizing service representative performance, generating a performance grade based on the sets of quantitative and qualitative data, and determining if the target performance grade has been met, and if the performance grade has been met, paying the service representative based upon said successful performance grade and if the performance grade has not been met, then paying displaying a the performance grade.

Despite these advances in the art, it will be apparent from the foregoing that there is still a need for a method and system for enhancing call center performance.

### SUMMARY OF THE INVENTION

In one aspect, provided is a method for improving call center performance. The method includes the steps of, for each call, collecting data comprising: date, supervisor, associate, and a categorization as to single, last, or transfer; summarizing said data on a periodic basis by supervisor, associate, and percentage of single, last, transfer, and stream, wherein percentage of stream is the residual after subtracting said percentage of single, last, and transfer categories; and presenting said summarized data to supervisors to provide feedback on the effectiveness of said supervisor's call coaching of associates.

In another aspect, provided is a method for enhancing call center performance. The method includes the steps of, for each call, collecting data comprising the date, call sequence, caller ID, associate, and associate's supervisor, categorizing said data as to a first or last call, and for each caller ID periodically counting the number of total, first, and last calls, preparing reports corresponding to said period summarizing, for each associate, the total and the combined first plus last calls as a percent of the total calls for said associates and presenting reports to supervisory personnel.

In yet another aspect, provided is a system for enhancing call center performance. The system includes a customer service system that, for each call, collects call data comprising the date, call sequence, caller ID, associate, and associate's supervisor and stores said information in a data warehouse, a data warehouse, a categorizing system for accessing said data warehouse and categorizing said data as to a first or last call, and for each caller ID, counting the number of total, first, and last calls, a report generating system for preparing reports summarizing, for each associate, the total and the combined first plus last calls as a percent of the total calls for said associates and a system for displaying said reports.

These and other features are described herein with specificity so as to make the present invention understandable to one of ordinary skill in the art.

### BRIEF DESCRIPTION OF THE DRAWINGS

The invention is further explained in the description that follows with reference to the drawings illustrating, by way of non-limiting examples, various embodiments of the invention wherein:

FIG. 1 is a schematic overview of the physical environment and overall operation of the present invention;

FIG. 2 presents overall data processing steps, in accordance with the present invention;

FIG. 3 is a screen shot of a table generated for a single month;

FIG. 4 presents a pivot table report showing year to date report for Manger A, by Employee, by month; and

FIG. 5 is a block diagram outlining the overall process steps of the present invention.

### DETAILED DESCRIPTION OF THE INVENTION

Disclosed herein is a method and system for enhancing call center performance, each now described in specific terms sufficient to teach one of skill in the practice thereof. In the description that follows, numerous specific details are set forth by way of example for the purposes of explanation and in furtherance of teaching one of skill in the art to practice the invention. It will, however, be understood that the invention is not limited to the specific embodiments disclosed and discussed herein and that the invention can be practiced without such specific details and/or substitutes therefor. The present invention is limited only by the appended claims and may include various other embodiments which are not particularly described herein but which remain within the scope and spirit of the present invention.

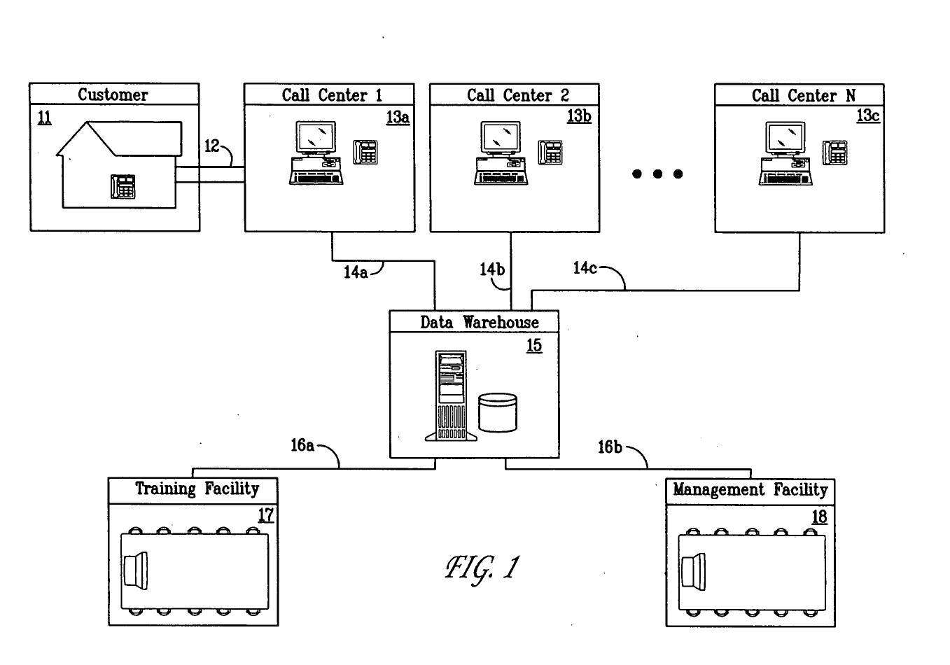

FIG. 1 illustrates, schematically, the physical environment and overall operation of the invention. For an inbound call center, a customer 11, illustrated by the personal residence, places a call over telephone wires 12 to call center 13a. Of course, customer calls could be made using cell phones or other oral communications devices. Based on any of various protocols, the call is routed to an associate of the company (not shown) equipped with a telephone and a computer. This routing is usually accomplished with an automatic call distribution system comprising both hardware and software. Computers in a typical call center are controlled by a customer service or inquiry system that is specialized to handle the type of transactions processed by the call center. Within the constraints discussed below, this also is not an essential part of the invention. A discussion ensues in which the associate attempts to resolve whatever problem or issue prompted the customer to call.

During the call, the associate will use the inquiry system to look up information about the caller, the caller's inquiry, and whatever other information might be useful. Generally, the associate will open a computer file for that particular customer; usually one that is part of a database specialized for that particular call center's operations. A large software industry has developed to supply such database software, but the invention can be used with any of the common designs.

A call inquiry usually requires the associate to look up and communicate information and enter information from the customer. After the call, additional information may be entered and sent to other operational groups for further processing. From the customer's standpoint, this was preferably the first and only call.

The invention can encompass one or more call centers 13b and 13c with suitable connections to customers (not illustrated). Call centers may be virtual call centers in that some or all associates may work in separate physical locations. Each call center may use different computer systems as long as each customer record contains the core data fields described below.

Normally, customer call inquiry records are continuously sent from call centers 13 to a Data Warehouse 15 over communications lines 14. For the purposes of this invention, records may be sent continuously or periodically, e.g., once per month. Typically, the communications lines will be land lines, but through-the-air communication may be used for some or all of the lines. The data warehouse may house a single dedicated server or several servers. In one embodiment, the data warehouse is a virtual warehouse comprising a network of servers. In another embodiment, each call center or centers 13 contains servers cooperating to form the virtual data warehouse. In the latter embodiment, call centers would not connect to a central data warehouse.

Information in the data warehouse is processed according to the steps discussed below to provide distilled information call reports that may be used in two ways. First, the call reports may be used to provide feedback to associates in training sessions, in a Training Facility 17, given to help associates improve performance and efficiency. Second, call reports may be used to help management personnel in a Management Facility 18 monitor the strengths and weaknesses of individual associates, teams of associates, business units, and call centers. As indicated, in a typical use, call reports will be displayed on a computer screen for use by participants. In some situations, call reports may be presented on printed paper.

Connections to the data warehouse or virtual data warehouse will also require communications means 16a and 16b, respectively. In the case of a virtual data warehouse utilizing servers in call centers, communications means 16a and 16b would connect directly to call centers. In one embodiment, the facility to train associates and inform management may be physically at the same location.

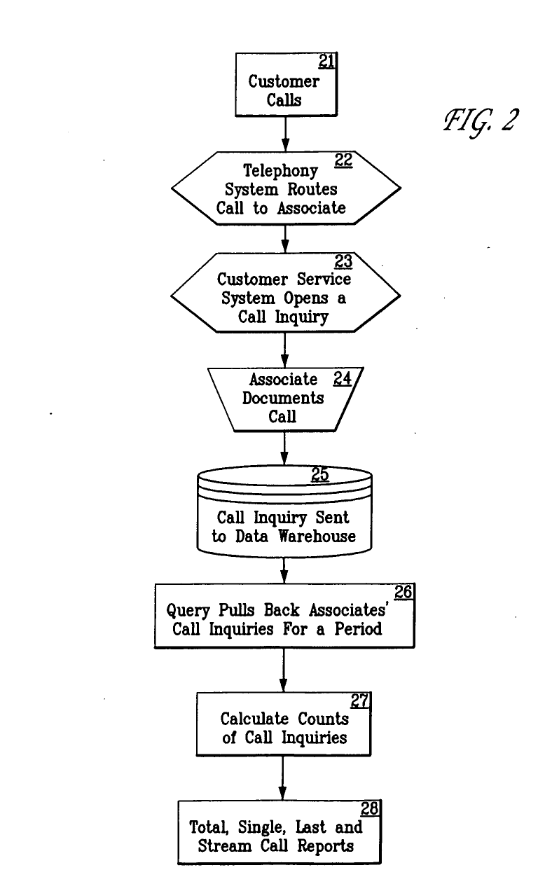

An overview of the operation and facilities has been presented. Referring now to FIG. 2, the overall data processing steps are presented. Steps 21-25 have been described above for any number of call inquiries. For a single call inquiry, the Steps 21-25 are much the same. At the end of Step 25, records for all call inquiries have been collected in the Data Warehouse.

As noted, these records will typically be part of a database system. The information for each call inquiry is collected and entered in a database object or table. The tables are similar to spreadsheets with each row corresponding to a call inquiry. There are many ways to organize the database. Early relational databases stored files as two dimensional tables; like a spreadsheet without formulas in the cells. Later, multidimensional database were developed with separate tables (database objects) for different categories of information (dimensions). This set is often called a cube, even though multidimensional. However organized, the tables usually contain records in rows with data field columns. Tables for a call inquiry may contain many fields; several dozen or more is typical. Different sets of fields would be appropriate for different types of call centers.

As noted above, the call inquiry records may contain many information fields necessary for call center operations. However, for this invention, the record must contain a minimum core set of data fields: 1) the date of transaction, 2) a customer identifier or caller ID, which may be an order number, member ID, contract number, or other unique identifier, even a telephone number; 3) the name of the associate or equivalent unique identifier, and 4) a sequence number or other indication of the order of calls throughout the day. The sequence number may be keyed to the customer identifier. However, it may be a sequence number for all calls to the call center as long as it increases with time of day and does not start over during the day.

Other information such as the name of the associate's supervisor and the call center, if more than one, may be part of the record or derived from the database, depending on its organization. In one embodiment, useful information includes a business unit within the call center. In the context of expediting orders, useful information might include the selling merchant and the warehouse. In general, the record may include many details about the call that are important for operation of the overall enterprise, but not necessary for operation of this invention.

In Step 26, a database management system pulls back the records for Call Inquires from the Data Warehouse. The period is usually a calendar month, but any period may be used. The records include the core data fields plus any other information that might be useful. For convenience, these can be assembled into a single table (Results Table).

In Step 27, counts of call inquires are calculated. For each distinct caller, a count is made of the total number of calls (Total Calls) from that caller. In addition, the system determines whether it was the only call from that caller in the period (Single Call) and identifies the record which would identify the associate. If there was more than one call, the system determines which was the last call from that caller during the period (Last Call) and identifies that record. This information is added to the Results Table. The details of these determinations will be described in the Working Example.

In Step 28, the same or a different system uses the Results Table to generate reports. For each associate, a report is generated showing the count of Total, Single, Last, and Stream Calls. Stream Calls are calls that did not resolve the caller's problem. They can be calculated as Stream=Total−Single−Last. The Working Example will describe report generation in more detail, illustrated with example reports.

### WORKING EXAMPLE

The invention was implemented using a multidimensional database. A Hyperion Intelligence Release 6.6.4 database management system was use to access data in the Data Warehouse, analyze it and produce separate reports of Total, Single, and Last Calls, by supervisor, by associate. These were exported into Excel spreadsheets to calculate Stream Calls and various percentages and produce the final reports.

Below is a description of the tables accessed from the warehouse, steps to extract data from them and combine them into a single table that was then analyzed to find First, Last and Total Call numbers. As is customary, the steps are in the form of a series of queries.

Note however, that Hyperion uses its own ALE (Analytic Language for Expression), a code that is loosely based on SQL, but those familiar with SQL will not find it hard to follow. SQL does not have IF, THEN, ELSE statements. These are executed using stored program code, but the pseudo code listed below is self explanatory.

The multidimensional database was organized into six tables, each representing a dimension to the data. ALn are aliases, names that can be used with standard SQL dot notation to conveniently select data. The six with the important columns listed were:

### Method_Dim-AL1: {Method_ID}, Contact_Method, Broad_Method, Method_Description,

### Inquiry_Daily_Fact-AL2: {Day}, {Method_ID}, {UOW_Originator_Type_ID}, {Inquiry_CSR_ID}, {DSU_ID}, Source_System, Number_of_New_Inquiries, UOW_Key, UOW_Key_Description, Contract_No

### Time_Dim-AL3: Day, Month_Description, Month

### Originator_Type_Dim-AL4: {UOW_Originator_Type_ID}, Enterprise_Originator_Type, UOW_Originator_Type_Description

### Inquiry_CSR_Dim-AL5: {Inquiry_CSR_ID}, Inquiry_CSR_Description, Supervisor_ID, Supervisor_Description

### Service_Group_Dim-AL6: {DSU_ID}, Business_Unit, Service_Group_Name

In the above, UOW=Unit of Work, e.g., a telephone call. CSR=Customer Service Representative, the associate discussed previously. DSU=Designated Service Unit. Originator refers to the caller. With respect to the ID and Description pairs, a Description means a name. ID fields are not necessary if the Description is a unique alphanumeric string. However, it is customary to associate a numerical string with the description to avoid having mismatches based on spaces, periods and the like when actual names are used.

The Contract_No is unique to each caller or the caller's family as the case may be. It is the caller ID discussed above.

Rather than row numbers, tables have primary keys in one column. To match rows in different tables, foreign keys are used. The keys are listed in { . . . }s.

### ‘Mthly UOW CSR Totals Query’:

To create a table, ‘Monthly CSR Totals’, an SGL like query on the database is performed with an SQL-like SELECT, FROM, WHERE, GROUP sequence of statements.

### SELECT AL3.Day, AL2.Source_System, SUM AL2.Number_of_New_Inquiries), AL6.DSU_ID, AL5.Inquiry_CSR_ID, AL5.Supervisor_Description,

COUNT (DISTINCT (AL2.UOW_Key)), AL5.Supervisor_ID, AL2.UOW_Key_Description, AL5.Inquiry_CSR_Description, AL5.Inquiry_CSR, AL6.Business_Unit, AL6.Service_Group_Name, AL3.Month_Description, AL3.Month, AL1.Contact_Method, AL1. Broad_Method, AL1. Method_Description,

### AL4. Enterprise_Originator_Type, AL4. UOW_Originator Type Description, AL2.Contract_No.

The COUNT (DISTINCT (AL2.UOW_Key)) statements count the number of distinct phone calls.

### FROM dbo.Method_Dim AL1, dbo.Inquiry_Daily_Fact AL2, dbo.Time_Dim AL3,

### dbo.Originator_Type_Dim AL4, dbo.Inquiry_CSR_Dim AL5, dbo.Service_Group_Dim AL6

Here “dbo” means database objects, a standard terminology for table in a multidimensional database. The arguments are not standard SQL, but the effect is the same. This actually specifies a set of data that is at the intersection of all six dimensions.

### WHERE

### (AL2.Method_ID=AL1.Method_ID AND AL3.Day=AL2.Day AND AL4.UOW_Originator_Type_ID=AL2.UOW_Originator_Type_ID AND AL5.Inquiry_CSR_ID=AL2.Inquiry_CSR_ID AND AL6.DSU_ID=AL2.DSU_ID)

This matches up the rows in each table.

### AND (AL3.Month=200609)

This selects a month, e.g., September 2006.

### AND (AL4.Enterprise_Originator_Type=‘MEMBER’ OR

### (AL6.Service_Group_Name IN (‘SG1, ‘SG2, ‘SG3’) AND

### AL4. UOW_Originator_Type_Description=‘FAMILY MEMBER’))

This complication is because some service groups, SGn, handle families as a unit.

### AND AL1.Contact_Method=‘TELEPHONE’

### AND AL1.Method_Description NOT IN (‘COURTESY CALL BACK’, ‘IVR REQUEST’, ‘OUTGOING TELEPHONE CALL’)

These limit contacts to telephone calls and exclude the ones indicated. As above, IVR means interactive voice recognition.

### AND AL2.Number_of_New_Inquiries>=1

This excludes CSRs who had no new inquiries for the month.

### AND (NOT AL2.Contract_No=‘NA’)

### AND (NOT AL2.Contract_No LIKE ‘000000000%’)

### AND (NOT AL6.Business_Unit=‘XYZ’))

These statements exclude invalid contract numbers and a particular business unit.

GROUP BY AL3.Day, AL2.Source_System, AL6.DSU, AL5.Inquiry_CSR_ID, AL5.Supervisor_Description, AL5.Supervisor, AL2.UOW_Key_Description, AL5.Inquiry_CSR_Description, AL5.Inquiry_CSR, AL6.Business_Unit, AL6.Service_Group_Name, AL3.Month_Description, AL3.Month, AL1.Contact_Method, AL1.Broad_Method, AL1.Method_Description, AL4. Enterprise_Originator_Type, AL4.UOW_Originator_Type_Description, AL2.Contract_No

GROUP means arrange rows in ascending alphanumeric order starting with Day. For Day=1, arrange rows by Source_System. For each Source_System, order by DSU_ID, for each DSU_ID, etc. Also, the columns are in the order indicated. This is not essential, but it means the primary key is ‘Day’.

The following are not SQL statements, but a representation of what Hyperion Intelligence is executing.

Create the following calculated fields in the ‘Mthly UOW CSR Totals Results’ set of ‘Mthly UOW CSR Totals Query’:

In the following steps, a new column is indicated ‘New_Column’, followed by an operation to produce the column.

1) ‘UOWMod’—{if (Source_System=‘SYS1’) {Substr(UOW_Key_Description, 8, 5)} else {if (Source_System=‘SYS2’) {Substr(UOW_Key_Description, 14, 5)} else {if (Source_System=‘SYS3’){Substr(UOW_Key_Description, 9, 11)} else {if (Source_System=‘SYS4’){Substr (UOW_Key_Description, 7, 4)}}}}

This creates a new column, ‘UOWMod’ by extracting substrings, depending on which system was being used, from ‘UOW_Key_Description’. “Substring (X, m, n)” means start at the m^{th} character and extract the next n characters. UOWMod is in fact a phone call sequence number. This is assigned by the Inquiry System for each call in sequence as part of the ‘UOW_Key_Description’. The complication comes about because the four systems were not designed with this invention in mind. Each had its own format for assigning sequence numbers somewhere in the ‘UOW_Key_Description’character string. Thus, when data mining in the Data Warehouse, it was necessary to extract the sequence with different substrings.

2) ‘UOW Order’—ToChar (Day, “mmddyyyy”)+UOWMod

This creates a new column, ‘UOWOrder’. ToChar puts Day in the format “mmddyyyy.” E.g., it converts Sep. 5, 2006 to 20060905. In this case, the + operator stands for concatenation. The string UOWMod is tacked onto the end of the formatted Day. How this can be useful will be explained.

### 3) ‘Find Last UOW’—ColMax (UOW_Order, Contract_No)

ColMax returns the largest alphanumeric value of UOW_Order for each ‘Contract_No’ to find the last Unit of Work (phone call) for that contract number and places it into a new column in the same row as the contract number. If there is only one phone call per day, the Day alone would be sufficient. However, if there is more than one, the latest call will have a higher UOWMod sequence number. In SYS1 and SYS2, the sequence number is in the last five digits. In SYS3, the sequence number is in 5 digits in the middle. However, the trailing extra alphanumeric characters do not affect the ColMax comparison. Thus, UOW_Order is the order of phone calls in time, form earliest to latest.

4) ‘Last UOW Indicator’—if (UOW_Order=Find_Last_UOW) {1} else {0}

Since, for a particular contract, ‘Find_Last_UOW’, is the last in the UOW_Order sequence, if the two are equal, that row must contain the last phone call in the sequence. A logical 1 is entered in a new column, ‘Last UOW Indicator’.

### 5) ‘Count of Contract No’—Count (Contract_No, Contract_No)

Count will count the number of rows in the column, ‘Contract_No’, for each distinct contract number. Thus, if a caller (identified by a unique contract number) made 5 calls, a 5 will be entered in the new column, ‘Count of Contract No’, opposite each of those contract numbers.

After the count step, a simplified version of the result might look like the following:

| | | | | | | |
|---|---|---|---|---|---|---|
| UOW- | | Contract | | | | |
| Order | Last_UOW | No | CSR | Indicator | Count | Cat. |

| | | | | | | |
|---|---|---|---|---|---|---|
| 101 | 225 | 1 | 1 | 0 | 5 | Stream |
| 104 | 225 | 1 | 2 | 0 | 5 | Stream |
| 105 | 225 | 1 | 3 | 0 | 5 | Stream |
| 110 | 116 | 2 | 1 | 0 | 3 | Stream |
| 113 | 116 | 2 | 1 | 0 | 3 | Stream |
| 116 | 116 | 2 | 1 | 1 | 3 | Last |
| 219 | 225 | 1 | 4 | 0 | 5 | Stream |
| 225 | 225 | 1 | 5 | 1 | 5 | Last |
| 233 | 233 | 3 | 6 | 1 | 1 | Single |

This is for a 2-day period, with 9 calls covering 3 different contract nos., handled by 6 different associates. The first character in ‘UOWOrder’ is the day. The second two is the concatenated sequence number which monotonically increases. Last ‘UOWOrder’ is the highest for each of the 3 contract nos. ‘Indictor’ is a logical 1, when UOWOrder=Last UOWOrder. ‘Count of ‘Contract no.'s were 5 for no. 1, 3 for no. 2, and 1 for no. 3. Since the count for no. 3 was 1 and the Indicator is a logical 1, it would be a Single. A last call would occur when the Indicator is a 1 but the Count is greater than 1. A count of the three categories has yet to be made, but those of ordinary skill in the art will appreciate that this is straightforward using WHERE statements or the equivalent.

Having produced and classified the call inquiry records for a month, the next step is to provide useful information in the form of pivot tables. These is a well known data mining technique that summarizes the information in many records and can be found, for example, in Microsoft Excel and many database management programs.

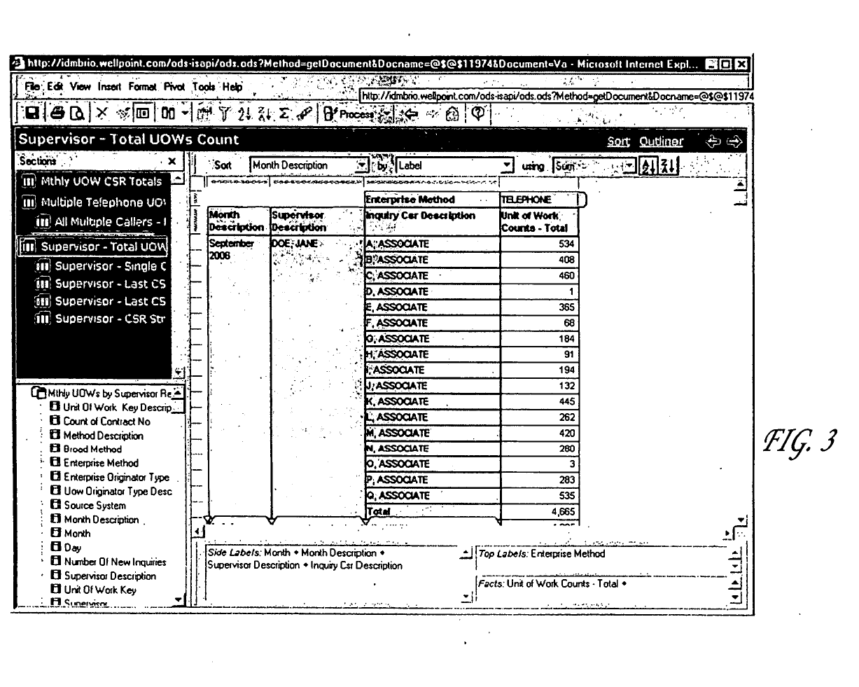

FIG. 3 is a screen shot of a table generated by the Hyperion system for the month of September 2006. It is ordered by supervisor (only one is shown), then by associate. Next to each associate is count of the total Units of Work (telephone call inquires) for the month. This corresponds to the number of rows in the previous table with the same CSR description.

Very similar pivot table reports were generated to show the number of Single and Last Calls. These look identical, except the last column heading and numbers are different and are not illustrated.

The next step was to export these reports into Microsoft Excel spreadsheets. This was for expediency. Certainly, other software programs could be used and the process further automated. Once the Total, Single, and Last pivot tables are exported to Excel, then it was straightforward to calculate Stream Calls as Total−Single−Last. Also, Single, Last, Stream and, in addition, (Single+Last) were calculated as a percentage of the Total.

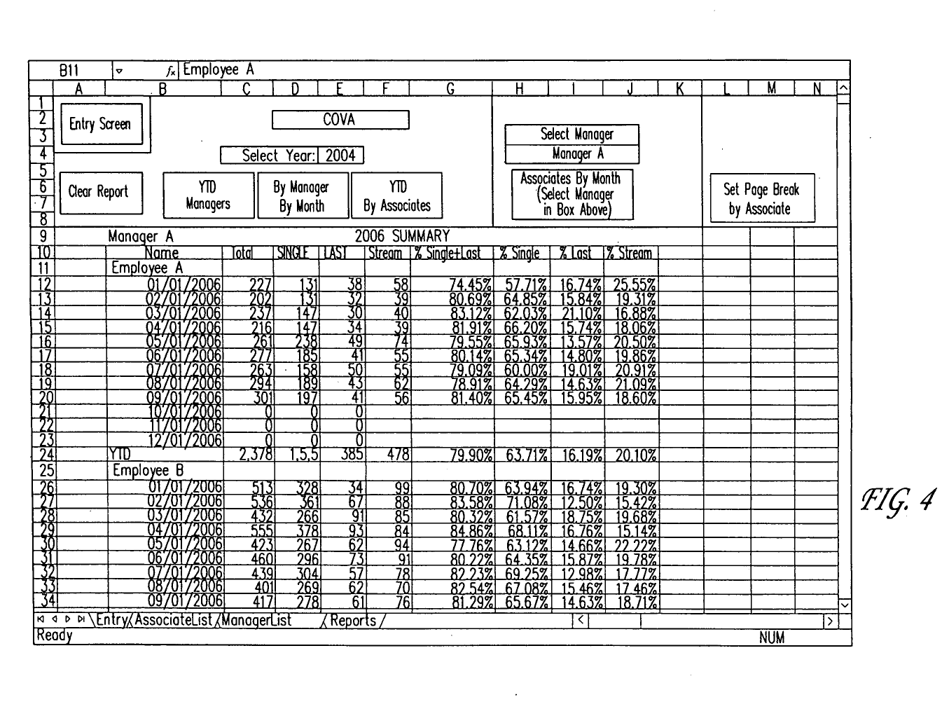

At this stage, many different pivot table reports can be generated using Excel macros. FIG. 4 illustrates one of them showing year-to-date report for Manger A, by Employee, by month. The macro bar at the top allows one to produce different reports, e.g., YTD Mangers (supervisor), By Manger by Month, YTD All Associates and the one shown, Associate by Month for a Selected Manager. This one is typical and shows Employee A's Total, Single, Last, Stream, % (Single+Last), % Single, % Last, and % Stream for each month.

### Use of Reports:

The pivot table reports can be used to provide feedback on many aspects of call center performance. One of the major uses is to improve the performance and efficiency of associates. The sample table below is atypical, but better illustrates the situation.

TABLE
Associates Under One Supervisor for One Month

| | | % (Single + | | | |
|---|---|---|---|---|---|
| Name | Total Calls | Last) | % Single | % Last | % Stream |
| N1 | 500 | 80 | 70 | 10 | 20 |
| N2 | 500 | 75 | 65 | 10 | 25 |
| N3 | 400 | 75 | 60 | 15 | 25 |
| N4 | 400 | 70 | 60 | 10 | 30 |
| N5 | 500 | 65 | 55 | 10 | 35 |
| N6 | 200 | 55 | 45 | 10 | 45 |

Six associates are listed with results for Total Calls and just the percentages for the other categories. The report could list total Single, Last, and Stream Calls, but the relative percentages are believed to be more useful. Ideally, % Single should be 100%, but this is hard to achieve. Currently, applicants believe a better approach is to focus on the percentage of Single and Last Calls combined. One could focus on reducing % Stream calls to zero, but this is less motivational.

As the table indicates, Associates N5 and N6 are less successful than the other associates. In the case of N6, the low Total may indicate a new employee. The high percentage of Stream Calls may indicate that N6 has to transfer a large number of calls to others. In the case of N5, the results may indicate an employee who is not new, but needs too many calls to resolve issues. In both cases, the supervisor can immediately see that some extra training would be beneficial.

This is accomplished with Call Coaching. This is based on dividing a call inquiry into six distinct stages: 1) Greeting, 2) Listening, 3) Transitioning, 4) Resolution, 5) Education, and 6) Closure. The purpose is to better focus on the aspect of a call where an associate is having trouble. With feedback from the reports, both the supervisor and associate will be motivated to find what part of the call inquiry is causing problems. In call centers that route follow-on calls to the previous associate, the educational aspect is significant for the associate. If neglected, customers call back when they did not have to, or call with further questions. If routing is to the next available agent, educating the customer will still reduce repeat calls for the business unit or call center, as the case may be.

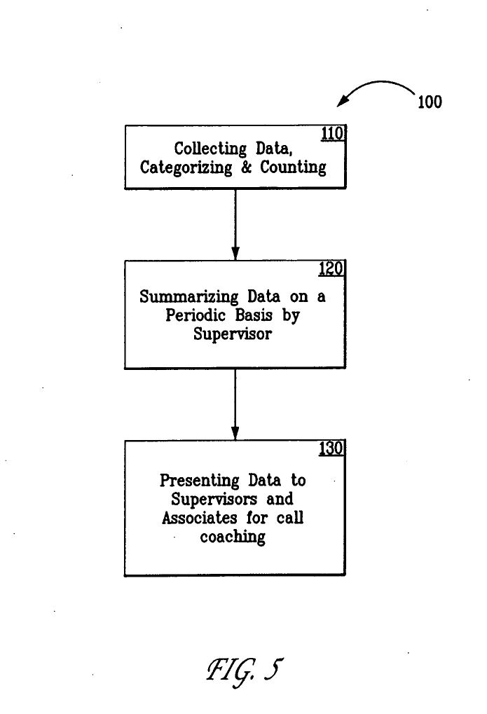

The major steps 100 summarizing this aspect of the invention are shown in FIG. 5. In Step 110, data from a call center is collected and categorized into Total, Single, and Last and the numbers counted. In Step 120, the results of Step 110 are used to calculate Stream Calls and percentages and summarized by supervisor, by associate. In Step 130, the results of Step 120 are used to produce reports of the data for use in call coaching.

Another use is the following. In most call centers, decisions about bonuses and promotion are performance-based. However, when there are no sales with a dollar value, it is not obvious on what these should be based. In situations where the associate is answering an inquiry to resolve a problem, a value cannot be easily attached other than that the problem was resolved. This invention, however, goes beyond mere resolution and looks at what drives customer satisfaction, namely, the resolution of a problem with only one call. In this call center environment, the % (Single+Last) can be used as the metric by which performance can be measured.

This metric can be used in two ways. First, rewards can be given for outstanding performance relative to other associates. Second, rewards can be given for improvement over time.

Bonuses and promotions apply not only at the associate level, but also to supervisors, business units and call centers. In this case, reports are generated which sum the Total, Single, Last, and Stream Calls for all associates under one supervisor and the percentages calculated for the supervisor's associates taken together. Similarly, reports can be generated for business units and call centers.

Each of these reports can be presented as a function of various time periods to find out if performance is improving or not.

The net result is to increase customer satisfaction by increasing % (Single+Last).

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

What is claimed is:

1. A method for improving call center performance, comprising:
a) for each call, collecting data comprising the date, call sequence, caller ID, associate, and associate's supervisor, categorizing said data as to a first or last call, and for each caller ID periodically counting the number of total, first, and last calls;
b) preparing reports corresponding to said period summarizing, for each associate, the total and the combined first plus last calls as a percent of the total calls for said associates; and
c) presenting reports to supervisors and associates to be used for call coaching of associates to improve performance.

2. The method of claim 1, wherein said call center is an inbound call center.

3. The method of claim 2, wherein said call center processes insurance claims.

4. The method of claim 2, wherein said call center processes health insurance coverage questions.

5. The method of claim 1, wherein said call center is virtual call center.

6. The method of claim 1, wherein said call center comprises a plurality of customer service systems.

7. The method of claim 1, wherein, in step a), categorization into first and last call comprises concatenating said call sequence data with said date data and, for each caller ID, determining the maximum resulting value to determine the last and single call categorizations.

8. The method of claim 7, wherein said call center comprises a plurality of systems having a plurality of sequence formats and said call sequence data is extracted therefrom.

9. The method of claim 1, wherein said reports are collected and prepared monthly.

10. The method of claim 1, wherein said call coaching comprises dividing call inquires into six stages consisting of: greeting, listening, transitioning, resolution, education, and closure.

11. The method of claim 2, wherein the call center uses next available agent routing.

12. The method of claim 1, wherein, in step a) call data is stored in a data warehouse and periodically accessed to produce categorization and total results for said period.

13. A method for enhancing call center performance comprising:
a) for each call, collecting data comprising the date, call sequence, caller ID, associate, and associate's supervisor, categorizing said data as to a first or last call, and for each caller ID periodically counting the number of total, first, and last calls;
b) preparing reports corresponding to said period summarizing, for each associate, the total and the combined first plus last calls as a percent of the total calls for said associates; and
c) presenting reports to supervisory personnel.

14. A system for enhancing call center performance, comprising:
a) a customer service system that, for each call, collects call data comprising the date, call sequence, caller ID, associate, and associate's supervisor and stores said information in a data warehouse;
b) a data warehouse;
c) a categorizing system for accessing said data warehouse and categorizing said data as to a first or last call, and for each caller ID, counting the number of total, first, and last calls;
d) a report generating system for preparing reports summarizing, for each associate, the total and the combined first plus last calls as a percent of the total calls for said associates; and
e) a system for displaying said reports.

15. The system of claim 14, wherein said data warehouse is a virtual data warehouse.

16. The system of claim 14, comprising a plurality of call centers.

17. The system of claim 14, wherein said call center is an inbound call center.

18. The system of claim 14, wherein said call center processes insurance claims.

19. The system of claim 14, wherein said call center processes health insurance coverage questions.

20. The system of claim 14, wherein said reports are collected and prepared monthly.

21. The system of claim 14, wherein said call center uses next available agent routing.

22. The system of claim 14, wherein said reports are presented to business unit managers for determining the effectiveness of supervisors in improving call center efficiency.

23. The system of claim 14, wherein said call center comprises a plurality of business units and collected data further comprises business unit managers.

24. The system of claim 14, wherein said system for displaying said reports is a computer system.

25. The system of claim 14, wherein said call center comprises a plurality of systems having a plurality of sequence formats and said call sequence data is extracted therefrom.
